(19) United States
(12) Patent Application Publication
(10) Pub. No.: US 2026/0336154 A1
(43) Pub. Date: Oct. 29, 2026

(54) DRIVE SPROCKET

(71) Applicant: HUSQVARNA AB, Huskvarna (SE)

(72) Inventors: Patrik MELIN, Huskvarna (SE); Martin HOLMBERG, Huskvarna (SE)

(21) Appl. No.: 19/486,163

(22) PCT Filed: Apr. 15, 2024
(86) PCT No.: PCT/SE2024/050355

§ 371 Date: Nov. 21, 2025

(30) Foreign Application Priority Data
May 23, 2023 (SE) 2350617-3

(51) Int. Cl. B27B 17/08

(52) U.S. Cl. CPC B27B 17/08

(57) ABSTRACT

A cutting chain drive sprocket (5c) is configured to drive a cutting chain with drive links (12) and side links (10a). The sprocket (5c) comprises a set of spurs (6), arranged in a circularly symmetrical arrangement around a rotation axis and configured to engage with the drive links (12). Side flanges (16) are arranged axially outside of the set of spurs (6) and straddle the side links (10a) axially. Guide shoulders (20) are arranged to axially guide the drive links (12). A handheld power tool, such as a saw, comprises the drive sprocket (5c) and a cutting chain with drive links (12), and side links (10a). The distance between the guide shoulders (20) is smaller than the distance between the side links (10a). The distance between the side flanges (16) is greater than the distance between the side links (10a).

### FIELD OF THE INVENTION

The present invention relates to a cutting chain drive sprocket, configured to drive a cutting chain having drive links straddled by side links, the sprocket comprising a set of spurs, arranged in a circularly symmetrical arrangement around a rotation axis and configured to drivingly engage with the drive links of the cutting chain, and side flanges arranged axially outside of the set of spurs.

The invention also relates to a set comprising a drive sprocket according to any of the preceding claims and a cutting chain, the cutting chain comprising drive links, axially straddled by side links.

The invention further relates to a drive shaft.

The invention also relates to a handheld power tool, such as a saw, comprising the set.

### BACKGROUND

Sprockets including a profile with spurs are well known in the field of handheld power tools, such as chain saws. EP0332743A1 and US2012030954A1 both disclose examples of such a sprocket. This type of sprocket is widely used for driving chains and the like, and many chains are designed to work with it.

Saw chains generally comprise three different types of links. These types are drive links, cutting links, and tie links. Drive links interact with the spur sprocket in the intervals between the spurs thereof. The drive links may be shaped and dimensioned to keep the links connected to them at an optimal distance radially from the spur sprocket, thereby ensuring the correct contact between the outer ends of the spurs and the connected links. Cutting links are provided with cutting teeth which each removes a small amount of the material with which it comes into contact, as the chain is driven during the operation of the saw. Tie links are connectors, which are arranged on the two outer lateral sides of the saw chain to connect drive links and cutting links into a closed loop. Both the tie links and the cutting links are connected to the drive links and may collectively be referred to as side links.

The side links may periodically contact with the spurs of the spur sprocket on the outer end of each spur. An indented surface on the edge portion of the tie link is designed for this contact. By the mutual contact, the alignment of the tie links in the direction of motion of the chain may be ensured. Also, hereby the correct position of the drive links in the intervals between the spurs is ensured.

Additionally, or as an alternative, there may be chains where only the drive links are designed to be in contact with the spurs.

A proper contact between the links and the spur sprocket is important, in order to minimize wear on both the chain and the sprocket as well as minimize the risk of chain or sprocket failure.

Power tools, which include cutting chains, are generally used in harsh environments. Some parts are, in order to perform their function, more exposed to the environment, and may be more prone to damages. One example of such a part is a cutting chain, which outside of the drive sprocket, mentioned above, runs along the outer edge of a guide bar in a chain saw. In the event of chain failures, it is highly desirable that further damages to the equipment may be minimized.

### SUMMARY

It is an object of the present invention to solve, or at least mitigate, parts or all of the above-mentioned problems. To this end, there is provided a drive sprocket comprising guide shoulders configured to axially guide the drive links on both axial sides thereof, and the side flanges are configured to, at least partly, straddle the side links axially.

Hereby the side flanges will straddle the guide shoulders and extend radially outside of them, such that the cutting chain may be at least partly countersunk in the edge area of the drive sprocket. The countersinking of the side links may, in some embodiments, mean that the rivets connecting the links are at least partly countersunk radially inside of the side flanges.

The cutting chain drive sprocket may work with saw chains designed for use with a spur sprocket, with an optimal function and minimal wear on all the parts. Non-aligned drive links, i. e. drive links that are not perpendicular to the axis of rotation of the drive sprocket may not fit into the axial spaces between the guide shoulders, and they may hence not be driven by the drive sprocket. This means that when a chain has been derailed from the guide bar, and is misaligned, it may not be driven further by the drive sprocket, which would damage the chain, the drive sprocket, as well as the equipment comprising the drive sprocket. The risk that the drive sprocket continues to drive a cutting chain is hence minimal, since the engagement of incoming drive links is obstructed by the guide shoulders. The chain climbs out of the drive sprocket by the drive links climbing on the guide shoulders, i. e. contacting their radially outer surface. Further on, the drive links of the chain may proceed to contact the radially outer edges of the side flanges.

The provision of narrow slots, intended for the countersinking of the drive links, between the guide shoulders, results in a non-engagement of misaligned drive links, and the drive sprocket and any other parts around it is protected from any possible damages from cutting links on a cutting chain being wound up around the drive sprocket.

Preferably, the side flanges and the guide shoulders together form countersunk spaces for the links of the cutting chain.

Hereby the drive links may be guided by the spaces, which are limited in the axial direction, between the guide shoulders. These slot-like spaces ensure that the drive links are aligned with the intended direction of motion around the drive sprocket. Also, the countersunk spaces radially outside of the guide shoulders may be shaped to allow enough room for the side links, such that they may rest on the surfaces on the radially outer ends of the sprocket spurs. Indented areas of the side links, i. e. tie links and cutting links, contact these surfaces of the spurs, while there is sufficient room radially outside of the guide shoulders to allow the connected drive links to be radially supported in the gaps between the spurs.

In one embodiment of the drive sprocket according to the disclosure, the guide shoulders comprise radially outer surfaces which are arranged perpendicular to the radius from the rotation axis.

Hereby any non-aligned drive links may remain at the radially outer surface of one or both of the guide shoulders. The drive links are not directed into the narrow slot between each pair of guide shoulders, since the guide shoulders are preferably not inclined towards the narrow slot. In some embodiments the guide shoulders may even be inclined away from the narrow slot, i. e. they are inclined towards the respective adjacent side flange When a drive link is riding on a guide shoulder, the next drive link, as seen in the direction of motion of the chain, may be even less inclined to enter the narrow slot. In fact, it may even climb further away from the narrow slot, i. e. to a position riding on the edge of a side flange, or even axially outside thereof.

In a further embodiment, the guide shoulders extend along a circle.

Hereby chains designed for use with conventional spur sprockets may be used with the drive sprocket according to the disclosure. The side links are allowed space to extend sideways from the spurs, since they extend tangentially or parallel to a tangent of the guide shoulders.

In some embodiments the guide shoulders comprise annular segments.

For example, the guide shoulders align along a circle perimeter, with the intervals between them filled by the spurs. The guide shoulders have a function solely in the gaps between the spurs, wherein they axially limit the available surface where the drive link may contact the flank surfaces of the spurs. If the drive links are not aligned to match the limited available surface, they may not contact the spurs, they may not be driven by the spurs, and the cutting chain may be derailed from the drive sprocket.

In a further embodiment, a radius of curvature of the annular segments of the guide shoulders is less than the outer radius of the side flanges.

Hereby the side flanges may be circular, and the annular segments of the guide shoulders may be arranged along the periphery of a circle which has a smaller radius than that of the side flanges. Smooth outer edges of the side flanges result, with the advantage that a derailed link may slide on the edge without being caught and dragged along around the sprocket thereby.

In an even further embodiment, the radius of curvature of the annular segments of the guide shoulders is between 0.5 and 3 mm less than the outer radius of the side flanges.

Hereby the side links in the chain are provided with a space allowing a tilting motion of the side links around the side edges, as seen in a tangential direction, of the end surfaces of the spurs. At the same time, the distance between the guide shoulders and the outer edge of the side flanges is small enough to allow the motion of a drive link from a position on a guide shoulder to a position on or axially outside of the side flanges.

In some embodiments the guide shoulders extend axially inwards from the side flanges.

Hereby the side flanges may act as outer, protective walls, which to some extent protect the links of a driven, aligned chain, while the side flanges assist in keeping non-aligned links, possibly from a derailed cutting chain, from being accidentally caught by the spurs in a non-controlled manner.

In some embodiments the guide shoulders are rigidly arranged at a fixed distance from the rotation axis.

Hereby the drive sprocket may function in a predictable manner, and the radial distance between the outer edges of the side flanges and the guide shoulders may be constant around the perimeter area of the drive sprocket.

In some embodiments the side flanges have at least the same radius as the radially outer ends of the set of spurs.

Hereby the risk that the spurs contact any misaligned drive links is minimized. The spurs only extend radially inside the side flanges.

In some embodiments the side flanges have a smooth, circular outer edge.

Hereby the chain links may slide on the edge of the side flange, with the effect that the side flanges of the drive sprocket neither drive nor entrail the links of the chain. When the drive links of the chain are no longer aligned with the narrow slots between the guide shoulders and are not driven by contact with the flanks of the spurs, the risk that other parts of the drive sprocket have a driving effect on the chain is eliminated.

In some embodiments the spurs, side flanges and guide shoulders of the sprocket are rigidly interconnected.

Hereby the drive sprocket may be manufactured from durable materials and be resistant to failure or wear from a long-term use.

In some embodiments the spurs, side flanges and guide shoulders of the sprocket are manufactured in one single, integral piece.

Hereby the drive sprocket may be manufactured in an easy, cost-efficient and automated manner in large series, e. g. by casting.

In some embodiments the drive sprocket comprises a drive shaft aperture, wherein an axis of the drive shaft aperture is arranged to coincide with the axis of rotation of the drive sprocket.

Hereby the drive sprocket may be mounted on a drive shaft of a motor in a power tool, either directly on the shaft or via an adapter mounted on the shaft. In an alternative embodiment, the sprocket comprises a drive shaft configured as a rod, extending axially outwards from one side flange, coinciding with the axis of rotation, and configured to mate with a drive slot of a power tool. Hereby the drive sprocket may be mounted in a power tool wherein the means of connection with the motor is an aperture into the motor at its axis of rotation.

In some embodiments an axial distance between the side flanges is between 3 and 8 millimeters, and the axial distance between the guide shoulders is 1 and 2 millimeters.

Hereby most chains including drive links and side links may fit between the side flanges and guide shoulders, respectively, under normal circumstances of use.

According to a second aspect, parts, or all, of the above-mentioned problems are solved, or at least mitigated, by a set wherein the axial distance between the guide shoulders is smaller than the lateral distance between the side links, and the axial distance between the side flanges is greater than the lateral distance between the side links.

Hereby the cutting chain and the drive sprocket interact, and their respective dimensions are selected such that certain dimensions in the drive sprocket require matching dimensions and qualities of the cutting chain. The width of the cutting chain is determined by the lateral distance between the outsides of the side links. This distance needs to be accommodated between the side flanges.

Each adjacent pair of drive links in the chain is interconnected by one pair of side links. Hereby different types of cutting chains, for different purposes and with different properties, may be attained.

The side links comprise cutting links and tie links. The cutting links may be arranged with short distances between them along the cutting chain, e. g. between all consecutive drive links, with a respective tie link on the opposite lateral side of each cutting link. Another example is where the cutting links are arranged at longer distances from one another, with several sets of drive links and respective tie links between them. Also, since the side links may not enter the space between the guide shoulders, the distance between the latter, in the axial direction of the drive sprocket, needs to be less than the lateral distance between the side links, i. e. the width of the chain.

The links as such may have different properties for different purposes of the chains. For example, in chains for wood cutting, the cutting links are provided with cutting edges, which are designed to each cut off small chips of wood. The cutting links are designed such that the thickness of the chips may be thin enough to keep the saw chain from getting stuck in the wood to be cut. Chains for concrete are designed with links that are abrasive, by the provision of a surface treatment, such as an abrasive coating or by otherwise causing link surfaces as such to be rough.

In an embodiment of the second aspect, the axial distance between the guide shoulders is between 1 and 1.5 times the thickness of a drive link.

Hereby the slot formed by the distance between the guide shoulders may allow the entrance of well aligned drive links, and hence the interaction between the drive links and the spurs of the drive sprocket may take place. A misaligned drive link, angled in relation to the slot may not enter the slot, and cannot be driven by the drive sprocket.

In an embodiment of the set, the radially outer ends of the set of spurs are shaped to contact the side links.

Hereby the side links, whether they are tie links or cutting links, are kept at a constant distance radially from the axis of rotation and in an alignment with the perimeter of the side flanges. The correctly positioned side links may, in their turn, keep the drive links from moving in their plane of extension, and hence keep them in their optimal drive contact with the set of spurs.

In another embodiment the axial distance between the side flanges is at least the combined thickness of one drive link and two side links.

Hereby the cutting chain may be at least partly countersunk between the side flanges, when the drive links are interacting with the spurs of the drive sprocket.

In a third aspect of the disclosure, a drive shaft for use with the set has an outer, free end, which is provided with meshing means, for meshing with a tool.

Hereby the drive shaft may be kept still in its rotational position, which may be an advantage, e. g. when mounting or exchanging a clutch. The need to do this is particularly great on an electric handheld tool, such as an electric chainsaw.

In an embodiment of the second aspect, the meshing means comprises a socket.

Hereby the meshing means may be independent of the outer profile of the shaft and does not interfere with any possible outer functions of the shaft. Also, meshing means configured as a socket does not require that a certain distance of the outer end of the drive shaft is accessible. Only the end face of the drive shaft, including the socket, needs to be accessible, and it may be countersunk, as long as it may be reached in an axial direction with an elongate tool, such as a screwdriver, an Allen key, a hexalobular tool, etc.

In a further embodiment, the the socket is hexagonal.

Hereby the socket may mesh with an Allen key, which is widely available, and is often elongate.

In some embodiments the meshing means comprises an outer profile on the drive shaft.

Hereby the drive shaft may be kept from rotating axially with a tool such as a monkey wrench, a socket wrench, etc. These tools are widely available and may be used when there is access to the drive shaft in a transversal direction thereto.

In a further embodiment, the outer profile is hexagonal.

In a fourth aspect of the disclosure, a handheld power tool, such as a saw (1), comprises the set mentioned above.

In some embodiments of the fourth aspect, the handheld power tool, comprises the drive shaft.

It is noted that embodiments of the disclosure may be embodied by all possible combinations of features recited in the claims. Further, it will be appreciated that the various embodiments described for the device are all combinable.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a side view of a chain saw comprising a disclosed drive sprocket;

FIG. 2a is a perspective view of one example of a prior art drive sprocket and a tie link;

FIG. 2b is a side view of the prior art drive sprocket according to FIG. 2a, interacting with a couple of chain links;

FIG. 3 is a perspective view of a second example of a prior art drive sprocket and a tie link;

FIG. 4 is a side view of the prior art drive sprocket according to FIG. 3, interacting with links of a mismatched chain;

FIG. 5 is a side view of a drive sprocket according to the disclosure;

FIG. 6a is a schematic side view of the drive sprocket according to FIG. 5, interacting with a couple of chain links; and

FIG. 6b is a side view of the drive sprocket and chain links of FIG. 6a.

All the figures are schematic, not necessarily to scale, and generally only show parts which are necessary in order to elucidate the embodiments, wherein other parts may be omitted.

### DETAILED DESCRIPTION OF THE EXEMPLARY EMBODIMENTS

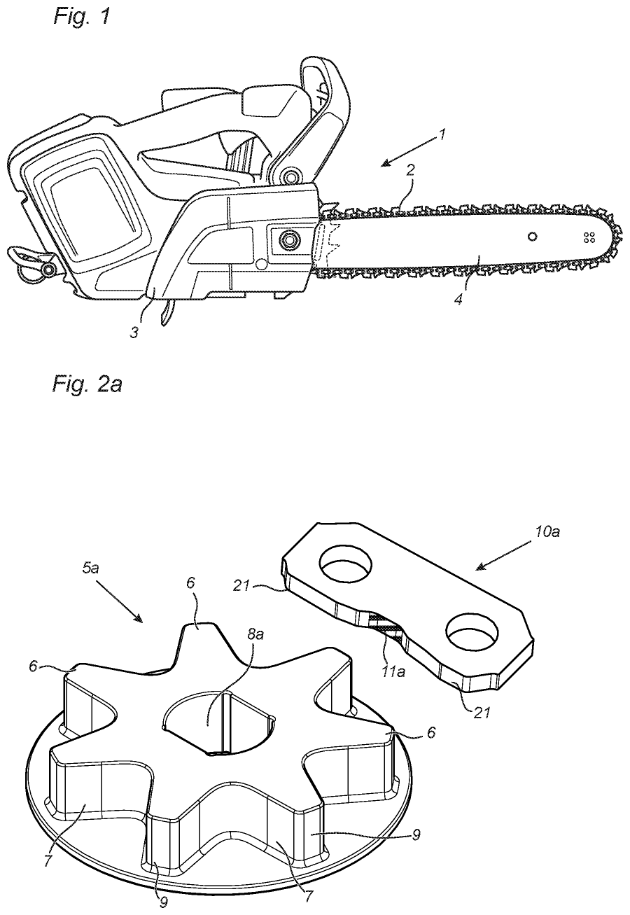

FIG. 1 illustrates a handheld chain saw 1 as an example of a power tool including a chain 2 driven by a drive sprocket (not shown in FIG. 1), which may be configured according to the disclosure. The chain saw 1 comprises a power head 3 with a motor and a guide bar 4 extending from the power head 3. The chain 2 is arranged to run along the edge of the guide bar 4 in an endless loop. The drive sprocket causing the chain 2 to move is rotated by the motor and is arranged to interact with the chain 2 at an inner portion of the endless loop inside the power head 3.

Chain saws 1, as well as other power tools are often operated in a harsh environment, and any moving parts, especially the chain 2, are vulnerable to damages and malfunctions. Also, moving parts need to be installed correctly and used with care, in order not to be subject to undue wear and subsequent failure.

One consequence of the harsh environment and the stresses that the chain 2 is subjected to is a derailing of the chain 2 from the guide bar 4. In case of such a derailing, there is a risk that the drive sprocket according to prior art will continue to drive the chain 2 by contact between the drive sprocket and some of the links in the chain 2. The derailed chain 2 will not run along the guide bar 4 as intended but may risk being coiled around the drive sprocket in one or more loops and may continue to be driven for some time after the chain jump, i. e. the derailing. The links of the chain 2 may come into cutting or abrading contact with inner parts of the power head 3 and cause damages thereto.

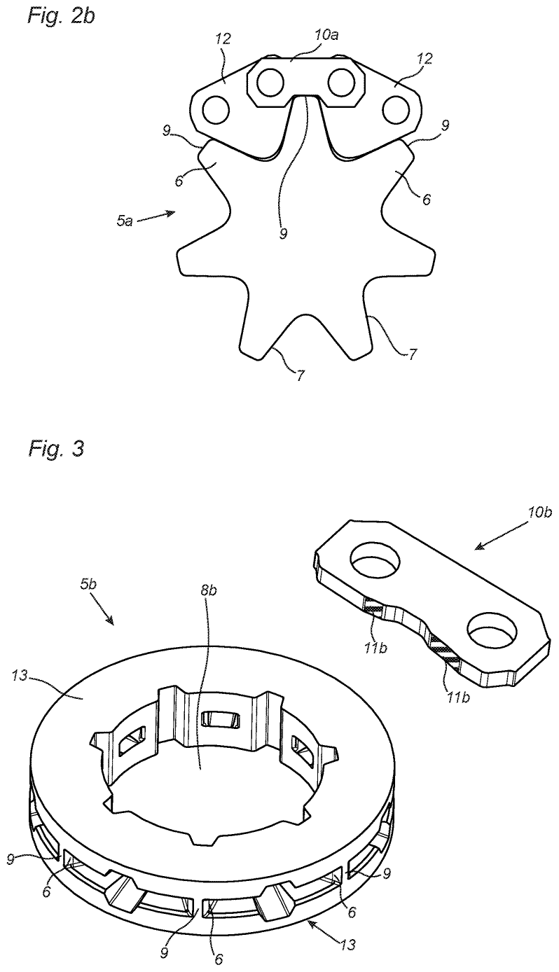

FIG. 2a illustrates an example of a drive sprocket 5a according to the prior art. The drive sprocket 5a is of a type commonly denoted as spur sprocket. The spur sprocket 5a comprises a number of spurs 6, with flank sides 7 arranged perpendicular to the main plane of extent of the sprocket 5a. The spurs 6 are arranged in a star-like manner, with a circular symmetry around an aperture 8a for a drive shaft. Flattened outer end surfaces 9 on the spurs 6 are also perpendicular to the main plane of extent of the sprocket 5a. The outer end surfaces 9 are intended for contact with dedicated contact surfaces 11a on side links, such as tie links 10a of the chain 2.

By the contact between the end surfaces 9 and the contact surfaces 11a, the side links 10a may be aligned at a well-defined distance to the center of the spur sprocket 5a, as seen in FIG. 2b. The side link 10a is approximately transversal to a radius extending from a rotational axis of the spur sprocket 5a to the outer end surface 9 of the spur 6. The alignment of the side link 10a is advantageous for keeping drive links 12, in their intended positions in contact with the flank surfaces 7 of the spurs 6. While the alignment of the chain 2 in the radial direction of the spur sprocket 5a is accomplished mainly by the contact between the side links 10a and the outer end surfaces 9 of the spurs 6, the driving force is transferred from the spur sprocket 5a to the chain 2 via the contact between the drive links 12 and the leading flank surfaces 7, i. e. in a narrow rectangular area, preferably defined by a trailing side edge of the drive link 12. Depending on the alignment if the chain 2, the contact may take place at many different locations on the leading flank surface of each spur 6, and the alignment or orientation of each drive link 12 is controlled only by the adjacent side links 10a.

FIG. 3 discloses another example of a prior art drive sprocket 5b, generally known as a rim sprocket. The general shape of the rim sprocket 5b is annular around a central opening 8b. The axial sides 13 of the rim sprocket 5b cover the spurs 6, and the gaps between them, such that the spurs 6 and their outer end surfaces 9 are barely discernible in FIG. 3. The drive links 12 of a chain 2 are intended to interact with the flank surfaces 7 of the spurs 6 in the same manner as has been described above for the spur sprocket 5a. There are slots 14 between the axial sides 13, and the drive links of the chain 2 may enter the slots 14 for the interaction with the rim sprocket 5b. The side links 10b of the chain 2, typically tie links and cutting links, are unable to contact the outer end surfaces 9 of the spurs 6, and instead each side link 10b contacts one of the axial sides 13 in two edge areas, with two contact surfaces 11b on each side link 10b.

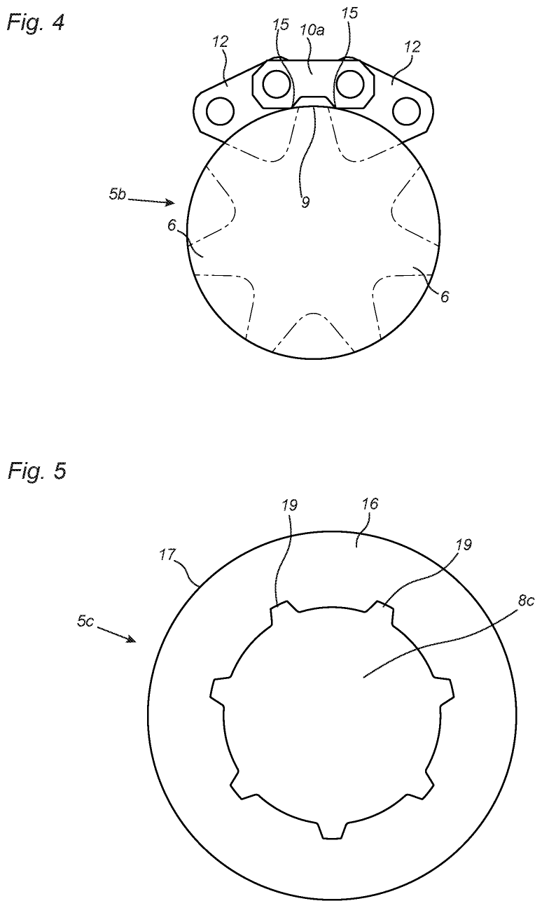

The drive sprockets 5a, 5b of FIGS. 2a-b and 3, respectively, work well under the correct circumstances, i. e. together with chains 2 that are designed for the respective type of drive sprocket 5a, 5b. However, not all types of chains 2 are manufactured in different versions for spur sprockets 5a and rim sprockets 5b, respectively. For this reason, chains 2 which were originally designed for use with spur sprockets 5a occasionally happen to be used with rim sprockets 5b, as shown in FIG. 4. The chain 2 will in most cases be driven by the rim sprocket 5b, at least for some time, but it is a serious disadvantage that the contact between the side links 10a and the drive sprocket 5b may not take place in the intended areas. The contact surfaces 11a on the side link 10a are unable to contact the end surfaces 9 on the spurs 6. Instead, only two thin lines 15 on each side link 10a may contact the outer edge of the axial sides 13 on the rim sprocket 5b. The concentrated contact areas 15 result in an excessive pressure in small areas on both the side links 10a and the axial sides 13. Over time, excessive wear and eventually failure of the components 5b, 10a may ensue.

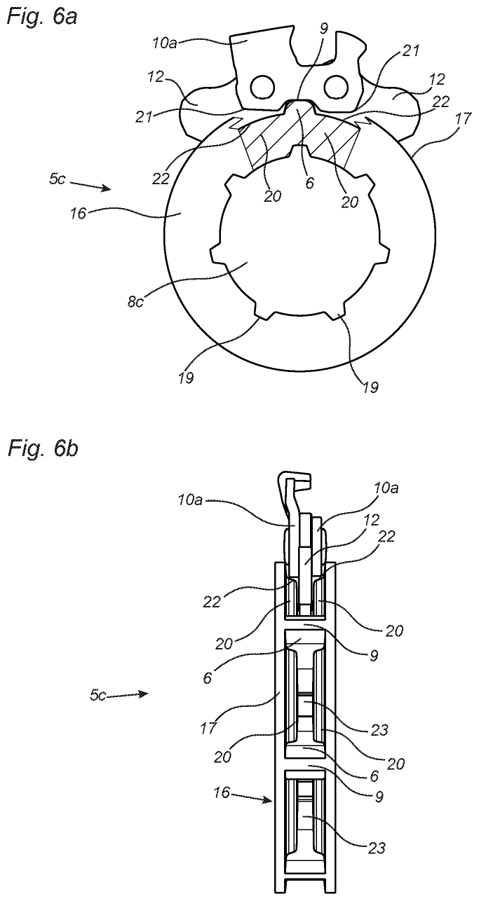

A drive sprocket 5c solving the above-mentioned problems is disclosed in FIGS. 5, 6a, and 6b. In the side view of FIG. 5, a side flange 16 on one of the axial sides of the drive sprocket 5c is visible. Each of the side flanges 16 has a smooth, circular outer edge 17. The drive sprocket 5c has a central aperture 8c, for attaching the sprocket 5c to a drive shaft of a power head 3 either directly or via an adapter. In the disclosed embodiment, the central aperture 8c is similar to that of the rim sprocket 5b, i. e. it has a generally circular shape with a number of notches 19 at its periphery. The number and shape of the notches 19 correspond to the number and shape of projections from a drive shaft of the power head 3 or from an adapter mounted on the drive shaft.

The drive shaft, as such, may in some embodiments be provided, at its outer, free end, with a socket for meshing with a tool, such as an Allen key, a Phillips screwdriver, or a flathead screwdriver, etc. In some embodiments the outer end of the drive shaft is, alternatively or additionally, provided with an outer profile, such as a square or hexagonal shape, which a wrench or other tool may grip from the outside. In all these embodiments, the drive shaft may be held in a constant rotational position, if needed, during the mounting or demounting of the drive sprocket or other equipment or during repairs of the power head 3.

In FIG. 6a a part of the side flange 16 has been cut away, to disclose an outer end of a spur 6 and guide shoulders 20 arranged in the gaps surrounding each spur 6. Also, one cutting link 10a and two drive links 12 are visible, to show their interaction with the drive sprocket 5c. The drive links 12 are of the same general shape as shown in the FIGS. 2b and 4, although they are partly obscured by the guide shoulders 20 in FIG. 6a. The drive links extend into contact with the spurs 6 of the drive sprocket 5c in a way closely corresponding to that of the contact with the spurs 6 in the prior art drive sprockets 5a, 5b, but they are limited by the guide shoulders 20 regarding their axial positions in contact with the spurs 6.

The cutting link and a parallel tie link (not visible in FIG. 6a), i. e. side links 10a, contact the outer end surface 9 of the spur 6 with their respective contact surfaces 11a (see FIG. 2a). Hence the wear is minimized on both the chain 2 and the drive sprocket 5c. The leading and trailing portions 21 of the lower edge of the side links 10a do not contact the drive sprocket 5c. In the gaps between the spurs 6, the guide shoulders 20 are arranged to extend radially outwards a shorter distance than the side flanges 16. This means that the side links 10a have some room to pivot slightly back and forth as needed around the edges of the outer end surface 9, without contact with the radially outer surfaces 22 of the guide shoulders 20.

Each of the drive links 12, on the other hand, extends into a narrow space between two guide shoulders 20 in the respective gaps between the spurs 6. The trailing edges of the drive links 12, relative to the direction of motion, will come into contact with a well-defined portion of the leading flank surfaces 7 of the spurs 6 as the drive sprocket 5c rotates. As seen in FIG. 6b, the two guide shoulders 20 form a narrow slot 23 between them, which is only slightly wider than the thickness of a drive link 12. This means that only well aligned drive links 12 fit into the narrow slots 23, and drive links 12, which try to enter the drive sprocket 5c at an angle to its tangential direction, will not be able to fit into the slots 23. They may end up riding on the radially outer surfaces 22 of the guide shoulders 20, on the outer edge 17 of one of the side flanges 16, or on, or near, the drive shaft, axially outside of the drive sprocket 5c. Neither the drive sprocket 5c nor the drive shaft are able to drive such drive links 12 that are not in contact with the spurs 6.

The main problematic situations, wherein the drive links 20 are not aligned with the tangential direction of the drive sprocket 5c, are when the chain 2 either derails from the guide bar 4 or breaks. When either of these two situations occur, the chain 2 will initially be pulled forward by the drive links 20 that are still aligned and are able to interact as intended with the drive sprocket 5c. However, drive links 12 in the trailing end of the chain 2 will sooner or later be misaligned, as a loose end next to a broken link 10a, 12, or derailed links 10a, 12 are drawn closer to the drive sprocket 5c. The misaligned drive links 12 may first ride on the radially outer surfaces 22 of the guide shoulders 20, as described above, when they are unable to enter the slots 23. They may also come to slide on one or both of the outer edges 17 of the side flanges 16. When the drive links 12 are no longer countersunk between the side flanges 16, they may even pull drive links 12 in front of them radially outwards from their positions between the guide shoulders 20.

When the drive links 12 are misaligned and no longer enter the slots 23 between the guide shoulders 20, they are no longer in contact with the flank surfaces 7 of the spurs 6, and they are no longer driven thereby. The result will soon be that no drive links 12 are in a position in any of the slots 23 to be driven by the drive sprocket 5a, and the motion of the chain 2 will stop. The smooth surfaces of the outer edges 17 of the side flanges 16 ensure that none of the links 10a, 10b 12 will be dragged along accidentally by the still rotating drive sprocket 5c. The links 10a, 10b 12 will merely slide thereon, until the operator of the power tool 1 has reacted and is able to turn off the motor of the power head 3. Further, the spurs 6 only extend radially inside of the outer edges 17, and they will hence not interact with any of the links 10a, 10b 12 when they are no longer properly aligned.

In short, a derailing or a breakage of the chain 2 will quickly lead to a derailing of the chain 2 from the drive sprocket 5c. Hereby the risk that a derailed or broken chain 2 may be wound several turns around the drive sprocket 5c is strongly reduced or even completely eliminated. The risk for damages to the drive sprocket 5c or to the interior of the power head 3 is reduced to the same extent. The result is that whenever a chain 2 derails from the guide bar 4, it will very soon derail also from the drive sprocket 5c before any serious damage has taken place. Unnecessary costs for repairs or replacement of parts are saved.

The invention has mainly been described above with reference to a few embodiments. However, as is readily appreciated by a person skilled in the art, other embodiments than the ones disclosed above are equally possible within the scope of the invention, as defined by the appended patent claims.

In the claims, the word “comprising” does not exclude other elements or steps, and the indefinite article “a” or “an” does not exclude a plurality.

1. A cutting chain drive sprocket, configured to drive a cutting chain having drive links straddled by side links, the sprocket comprising a set of spurs, arranged in a circularly symmetrical arrangement around a rotation axis and configured to drivingly engage with the drive links of the cutting chain, and side flanges arranged axially outside of the set of spurs, wherein the drive sprocket comprises guide shoulders configured to axially guide the drive links on both axial sides thereof, and the side flanges are configured to, at least partly, straddle the side links axially.

2. The drive sprocket according to claim 1, wherein the side flanges and the guide shoulders together form countersunk spaces for the links of the cutting chain.

3. The drive sprocket according to claim 1, wherein the guide shoulders comprise radially outer surfaces which are arranged perpendicular to the radius from the rotation axis.

4. The drive sprocket according to claim 1, wherein the guide shoulders extend along a circle or comprise annular segments.

5. (canceled)

6. The drive sprocket according to claim 5, wherein a radius of curvature of the annular segments of the guide shoulders is less than the outer radius of the side flanges.

7. The drive sprocket according to claim 6, wherein the radius of curvature of the annular segments of the guide shoulders is between 0.5 and 3 mm less than the outer radius of the side flanges.

8. The drive sprocket according to claim 1, wherein the guide shoulders extend axially inwards from the side flanges, or are rigidly arranged at a fixed distance from the rotation axis.

9. (canceled)

10. The drive sprocket according to claim 1, wherein the side flanges have at least the same radius as the radially outer ends of the set of spurs.

11. The drive sprocket according to claim 1, wherein the side flanges have a smooth, circular outer edge.

12. The drive sprocket according to claim 1, wherein the spurs, side flanges and guide shoulders of the sprocket are rigidly interconnected or are manufactured in one single, integral piece.

13. (canceled)

14. The drive sprocket according to claim 1, comprising a drive shaft aperture, wherein an axis of the drive shaft aperture is arranged to coincide with the axis of rotation of the drive sprocket.

15. The drive sprocket according to claim 1, wherein an axial distance between the side flanges is between 3 and 8 millimeters, and the axial distance between the guide shoulders is between 1 and 2 millimeters.

16. A set comprising a drive sprocket according to claim 1 and a cutting chain, the cutting chain comprising drive links, axially straddled by side links, wherein the axial distance between the guide shoulders is smaller than the lateral distance between the side links, and the axial distance between the side flanges is greater than the lateral distance between the side links.

17. The set according to claim 16, wherein the axial distance between the guide shoulders is between 1 and 1.5 times a thickness of a drive link,
wherein the radially outer ends of the set of spurs are shaped to contact the side links, or
wherein the axial distance between the side flanges is at least a combined thickness of one drive link and two side links.

18. (canceled)

19. (canceled)

20. A drive shaft for use with a set according to claim 16, the drive shaft having an outer, free end, wherein the outer, free end is provided with meshing means, for meshing with a tool.

21. The drive shaft according to claim 20, wherein the meshing means comprises a socket, and wherein the socket is hexagonal.

22. (canceled)

23. The drive shaft according to claim 20, wherein the meshing means comprises an outer profile on the drive shaft.

24. The drive shaft according to claim 23, wherein the outer profile is hexagonal.

25. A handheld power tool, such as a saw, comprising the set according to claim 16.

26. The handheld power tool according to claim 25, comprising the drive shaft for use with a set comprising a drive sprocket and a cutting chain, the cutting chain comprising drive links, axially straddled by side links, wherein the axial distance between the guide shoulders is smaller than the lateral distance between the side links, and the axial distance between the side flanges is greater than the lateral distance between the side links, wherein the drive shaft includes an outer, free end, wherein the outer, free end is provided with meshing means, for meshing with a tool.
